(19) United States
(12) Patent Application Publication
(10) Pub. No.: US 2022/0277394 A1
(43) Pub. Date: Sep. 1, 2022

(54) PROCESS AND SYSTEM FOR DEAL STRUCTURE OPTIMIZATION

(71) Applicant: Wells Fargo Bank, N.A., San Francisco, CA (US)

(72) Inventors: Carmel Nadav, Eagan, MN (US); Manish Pandey, Bengaluru (IN); Zachary Washam, Charlotte, NC (US)

(21) Appl. No.: 15/842,216

(22) Filed: Dec. 14, 2017

(51) Int. Cl. G06Q 40/06; G06F 15/18; G06Q 30/02; G06F 17/30

(52) U.S. Cl. CPC G06Q 40/06; G06F 15/18; G06Q 30/0201; G06F 17/30386

(57) ABSTRACT

Systems and methods create and modify augmented deal structure using specialized components working together in a technical system by aggregating and transforming inputs. Big Data issues are controlled and restriction rules along with specialized components work together to synthesize an augmented deal structure. This augmented structure is presented through a graphical user interface configured to provide at least one of an interactive analysis (providing sensitivity analytics) and a batch processing capability.

### BACKGROUND

Deal making in general and capital markets transactions in particular have been subject to academic research in various ways for long periods. Considered by some to be more art than science, capital markets deal processes have long been studied to enable more efficient and sustainable results. An example of academic interest includes the impact of asymmetric information on syndication, pricing a loan, and agency structure. However, studies have not jointly examined the number of prospective investors, such investors' appetite to participate, and the likelihood of varying degrees of capital commitment to a transaction. While raising capital is not a new endeavor, the disclosed innovation addresses a specific application with specific components working together in a specific manner in order to provide substantially more than a mere idea.

Raising capital on its own may be considered an abstract idea in that it is similar to such large scale economic concepts such as hedging or other general business concepts. Likewise, the term “merely automating” has been considered as not worthy of earning patent protection. However, innovation that does not preempt an abstract idea but instead involves an inventive application of the abstract idea (or portions of the abstract idea) have obtained the reward of patent protection. The present disclosed innovation is significantly more than mere automation. Often, systems must deal with ‘fat data at volumes and speeds that the term “mere automation” does not apply in the sense that a machine is merely doing that which a human may do (this is commonly referred to as “Big Data”).

Computer systems are often analogized to biologic systems. Innovation has striven to create artificial intelligence and analogized that intelligence to a human brain. Aside from any such use of literary analogies, computing systems are not biologic (or living) and are not living in the sense that humans are. Computing systems are not abstract, but are real— and deal with real machines and systems.

But this reality does not limit the usefulness of referring to computing systems with anthropic terms, especially discussing systems involved with incident responses, predictive analytics or decision modeling. Machines and systems of machines, and critically, innovations concerned with machines and systems of machines are often much more easily grasped and understood when anthropic terms are used. Terms such as “determining,” “predicting,” and the like are to be understood in their technical sense in this application.

Manual steps of a particular application of raising capital through a credit facility may include the labor intensive efforts of a banker spending a substantial amount of time searching for information about borrowers and lenders, evaluating borrowers' financial standing, liquidity, risk and more; determining type of facility and covenants, and in the final stages, inviting other lenders and allocating the lending amounts to each based on “art” or experience. No consistent systematic manner of doing this exists, so even the “mere automating” of these tasks may have been considered daunting. Further, mere automating while leveraging a computer's speed would not be able to leverage or increase confidence in any type of previous report, which would have been at best a report of past endeavors. There exists need for substantially more than such post hoc reports.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

The innovation broadly covers an ability to provide transformed deal structure involving response modeling with particular components that take as input proprietary data, public data, and selected restriction rules and apply machine learning with transformations of input data into new data structures that are synthesized into augmented deal structures. In particular, deal structures may revolve around raising capital, for example, in the creation of structured credit facilities, with the disclosed innovation providing the facilitation of efficient predictive lender selection along selective characteristics and business rules. Other applications of the disclosed innovation include peer lending, primary and secondary bond offerings, primary and secondary equity offerings, and leveraged finance syndications.

By applying components structured such that inputs are transformed in at least algorithms of modified knapsack and modified Herfindahl-H schman Index (“mod-HHI”) protocols, system processing may provide modeling capacity of up to several hundred deal characteristics and thousands of deal participant targets. Big Data difficulties such as cardinality and multicollinearity are mitigated and the resultant tool provides utility substantially beyond mere automation of any existing manual deal structuring.

An aspect of the innovation includes providing a graphical user friendly interface that provides in addition to an initial optimized credit facility, selector tools that allow for sensitivity analysis and exception configurations of deal structures, for example, credit facilities, by either of interactive real time or near real time structure reconfiguration or batch mode analysis.

The innovation disclosed and claimed herein, in one aspect thereof, includes systems and methods that provide for creating an augmented deal structure, the creation of which utilizes specialized components working together in a technical system. Components of this system include an aggregator component that aggregates proprietary and public data, a transformer component that transforms the aggregated data according to at least a set of restriction rules, a machine learning component that applies algorithms to the transformed, aggregated data, a synthesizer component that synthesizes an output of the machine learning component into an augmented deal structure, and a graphical user interface that provides selected characteristics of the augmented deal structure and provides at least one of an interactive analysis or intake for a batch processing of a set of modifications.

In another embodiment, a method for creating a predicted augmented deal structure from data inputs and restriction rules is presented. The method includes steps of aggregating data inputs that are received from proprietary data stores and public data stores that generate data key identifiers. The method also applies response modeling and transformation protocols that transform the incoming data inputs into data structures that ameliorate at least high cardinality and multicollinearity issues. This occurs because the transformation protocols apply machine learning and algorithm applicator techniques that include at least leveling, scoring, scaling and identification of data keys. These data keys are associated with restriction rules and the data key identifiers. Further, the restriction rules belong to at least subsets of restriction rules based at least in part on a type of deal for which the predicted deal structure is being created. The method also synthesizes the transformed data structures and associated data keys to yield an augmented deal structure and a selection of sensitivity factors of a subset of details of the augmented deal structure. Benefits of this synthesis include associating the data keys to indicators; and providing deal result structure output to a graphical user interface. Embodiments of the graphical user interface provide a consolidated view of the synthesized credit facility with indicators of selected characteristics of the credit facility, and interactive selector mechanisms that upon selection and modification provide sensitivity analysis capability from the predicted initial data structure to a newly created data structure with an impact score of the changed credit facility. Other embodiments of the graphical user interface provide at least the transformed deal structure, the selection of sensitivity factors and indicators that provide for interactive processing capability, batch process capability or both capabilities, with each of the capabilities providing sensitivity factor changes that can be reapplied to the synthesizing and that yields sensitivity analysis and perturbation analysis deal structure outputs.

In another embodiment, a non-transitory computer-readable medium configured to store instructions, that when executed by a processor, perform operations including one or more of the system and method steps.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 is an illustration of a high level example system 100 in context with one or more aspects of the disclosure.

FIG. 2 is an illustration of an example system 200 with components according to one or more embodiments.

FIG. 3 is an illustration of further example system components according to one or more embodiments 300.

FIG. 4 is an illustration of example system components, according to one or more embodiments 400.

FIG. 5 is an illustration of example system components, according to one or more embodiments 500.

FIG. 6 is an illustration of example system components, according to one or more embodiments 600.

FIG. 7 is an illustration of example system components, according to one or more embodiments 700.

FIG. 8 illustrates an embodiment of a method 800 according to one or more aspects of the disclosure.

FIG. 9 is an illustration of an example technical environment where one or more of the provisions set forth herein can be implemented, according to one or more embodiments.

FIG. 10 is an illustration of an example technical environment where one or more of the provisions set forth herein can be implemented, according to one or more embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details.

While specific characteristics are described herein, it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, the claimed subject matter can be implemented as a method, apparatus, or article of manufacture using programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. It is appreciated that embodiments are presented as a specific, non-limiting, examples of the innovation. Other embodiments are contemplated as well and intended to be included within the scope of this disclosure and claims appended hereto.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

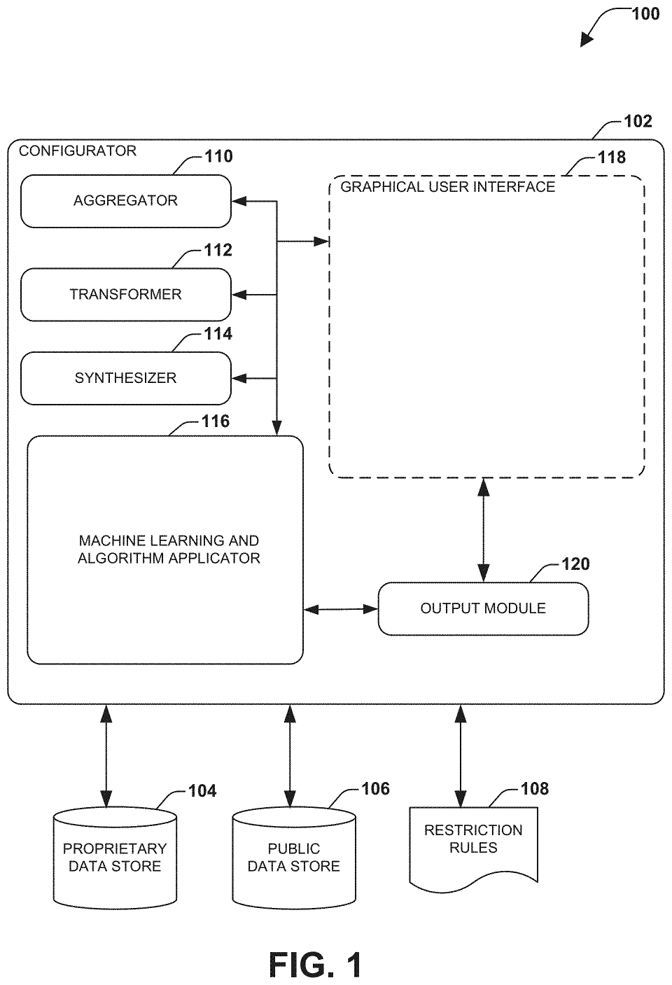

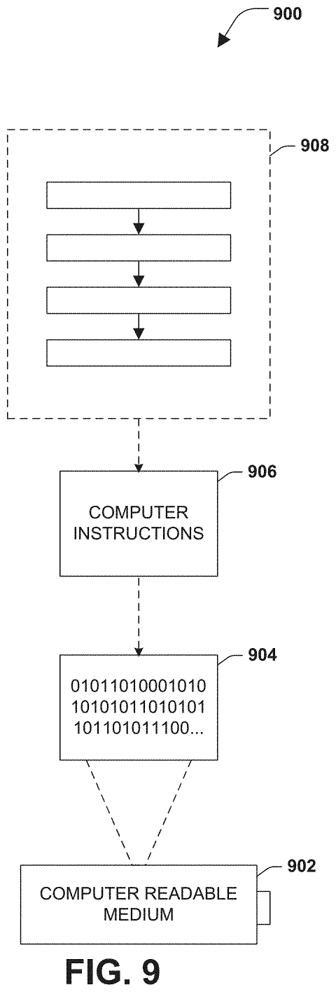

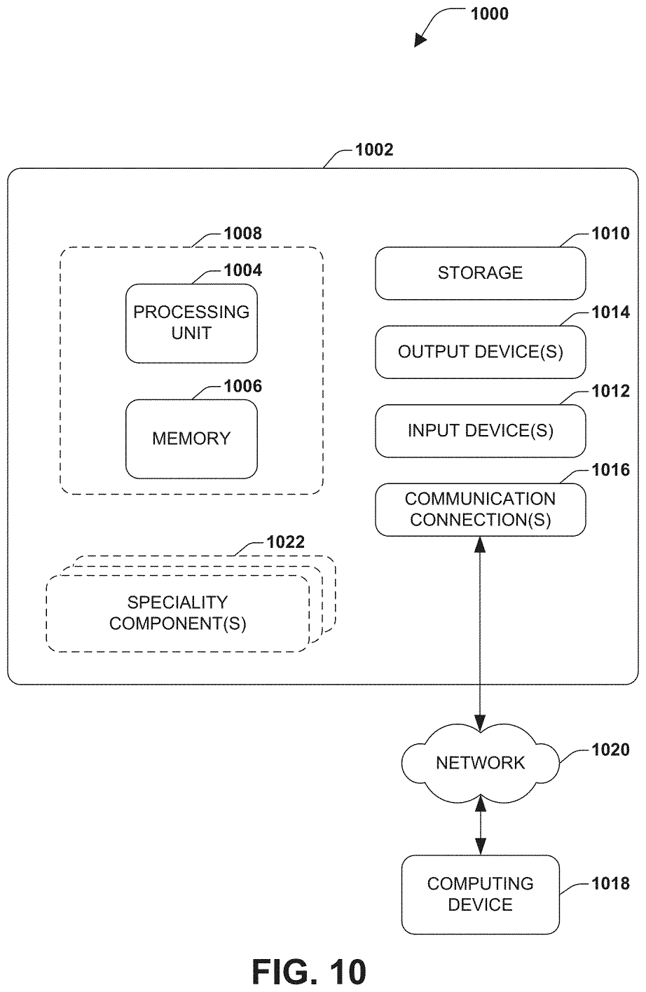

FIG. 1 is an illustration of a high level example system 100 in context with one or more aspects of the disclosure. System 100 indicates the technical context in which the innovation is placed. Technical context is also disclosed in relation to FIGS. 9 and 10, which will be discussed later. Configurator 102 may take as input data from a proprietary data store 104, a public data store 106 or a combination of a proprietary data store 104 and a public data store 106. As discussed later in view of FIG. 10, Configurator 102 is to be understood as being a specialty computing system, as opposed to being a generic computing system. The input from proprietary data store 104 may generally be in different contexts or formats from the input from the public data store 106. It is to be appreciated that proprietary data store 104 may be particular to a particular user of configurator 102 and that public data store 106 may comprise multiple sources of inputs, each with similar or different contexts or formats.

Configurator 102 may also take as input restriction rules 108. Restriction rules 108 may be business rules as selected from a subset of rules configured for a particular type of deal or for a particular user of configurator 102 or both. In some embodiments, restriction rules 108 may be fixed, as comprising a look-up table. In some embodiments, restriction rules 108 may be changeable and may reflect interactions with input data and/or machine learning and algorithm applicator component 116 as will be discussed herein.

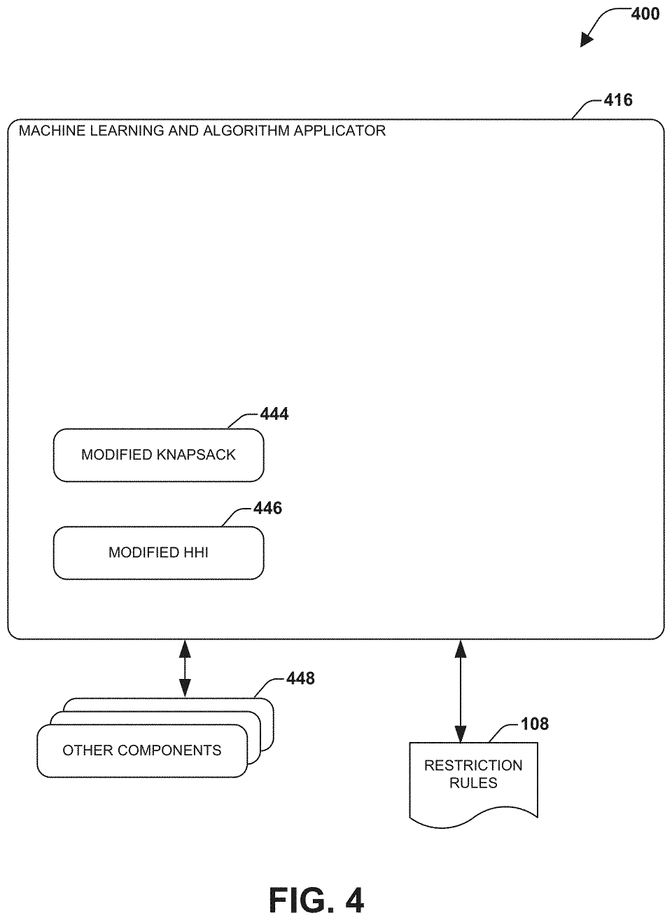

In embodiments, Configurator 102 comprises aggregator component 110. Aggregator component 110 is configured to receive inputs and restriction rules and in some embodiments in conjunction with machine learning and algorithm applicator (Herein “mlaaa”) 116 (as will be discussed herein, especially in relation to FIG. 4 later), transform the inputs into a state ready for transformer component 112. In other embodiments, aggregator component 110 may aggregate the inputs per a subset of rules received from restriction rules 108. Transformer component 112 transforms the aggregated inputs received from aggregator component 110. It is to be appreciated that transforming the inputs may also follow a subset of rules as received from restriction rules 108. In some embodiments, transformer component 112 interacts with mlaaa 116 as will be discussed herein.

The output of the transformer component 112 serves as input to the synthesizer component 114. In some embodiments, synthesizer component 114 synthesizes the transformed and aggregated inputs along a subset of restriction rules and generates a deal structure. In other embodiments, synthesizer 114 works in conjunction with mlaaa 116 (as will be discussed herein) in order to apply specific synthesis to the transformed and aggregated inputs to provide a deal structure. It is to be appreciated that the innovation disclosed in generating and providing augmented deal structures utilize the various components working together with inputs and restriction rules. The disclosed innovation reaches through available data (both public and proprietary data) and generates indicators associated with a deal; for example in a credit facility deal, generated indicators include an identified host of lenders and their ongoing appetite (level) and willingness (likelihood to commit) to loans based on a synthesis component as well as mlaaa 116 (as will be further discussed in relation to FIG. 4 later). Processing, including, for example scale with input factors including hundreds of variables that no human, even with pencil and paper would consider condensing into a response modeling. Included in the transformation is a modified market concentration metric (for example herein modified Herfindahl-Hirschman Index (“mod-HHI”) that provides non-linear feedback based on the combination of inputs. Non-modified HHI has been used in other applications such as, for example, evaluating market concentration for monopoly and anti-trust evaluations. The innovation realizes that the tactic may be applied in a modified manner to a host of captured input parameters. It is to be appreciated that mlaaa 116 provides the structure of these algorithms.

In embodiments, configurator 102 comprises a mlaaa 116. Mlaaa 116 interacts with other components of configurator 102 so that components provide synergistic (e.g., non-linear) returns. Inputs from restriction rules component 108 may provide the type of deal and a subset of the restriction rules then guide the interaction of mlaaa 116 with various components. Mlaaa 116 provides a predictive algorithm that in conjunction with transformer component 112 yields deal parameters that are then synthesized by synthesizer component 114 into a deal structure that augments the structure based on inputs and restriction rules. Augmentation beyond mere automation includes creating components for a system whose functionality is currently not captured in any manual process. For example, it has been discovered during the development of the present innovation that a predictive algorithm can be used to optimize certain factors of a deal, for example, a loan subscription process which reliably raises greater quantities of debt at a lower cost of capital or minimizes the risk of transaction failure given specific transaction criteria as determined by the issuer due to the augmented structure of the deal. The disclosed innovation, by setting out as a goal the identification of an optimized number and composition of lenders from a pool of lenders (said optimized number neither being too large, nor being too small, and said composition tailoring the lender group to unique transaction characteristics) along with components transformed from a set algorithm, yields an increased confidence that lenders will find the conditions conducive to their goals in a first pass yield. The configurator 102 then further provides a sensitivity analytics capability through graphical user interface 118 that provides for efficient predicting deal characteristics, such as for example lender selection for a particular deal, for example, a credit facility with raising capital accounting for perturbations to the predicted ideal, along with resultant identification of changed outcome levels all without a need for a complete start-over-from-scratch effort that such changes may have caused, even if such changes could be have been contemplated, as the pre-innovation techniques did not include such tactics. The configurator 102 provides sufficiently more than a manual (or even an automated version of a manual) system in that response modeling and machine learning between components and their functions, thus providing synergistic capabilities.

For example, a successful strategy for marketing a syndicated credit facility depends on correctly predicting lender participation levels and optimizing participation invitation amounts to oversubscribe the transaction to a comfortable level. Using traditional methods, developing such a marketing strategy is a complicated, slow, and technically limited process. Selection of participants is a costly and time consuming task requiring search, retrieval, and evaluation of information from multiple sources. Due to these practical limitations, there is a risk of delivering structurally sub-optimal deals to clients or deal failure altogether if the number and/or composition of lenders does not align with such lenders' behavioral profiles and credit appetite. Manual processes are unidimensional and cannot fully leverage the thousands of observations of available data to identify behavioral patterns that would facilitate a more effective transaction syndication strategy. Further, manual processes perform poorly at constructing prospective lender pools and are not capable of quantifying participation risk.

The innovation, as disclosed, with components built to interact and transform the inputs and synthesize a new structure, provide something different than previous manual processes. The synthesized results develop statistically significant behavioral profiles, and the disclosed innovation augments deal structure by narrowing lender pools, but also preventing that narrowing from going too far. As a result of the nonlinear interactions provided by the system components, synergy is achieved and a predictive algorithm that quickly identifies and presents an augmented deal structure, with key characteristics, for example, small number of lenders from a pool of lenders that will commit to execute a deal. Not only is such a pool identified (with the quantity of the pool identified, the inputs and restriction rules also serve as inputs to the synthesizer such that the structure of the deal may include quantity, and identity of participants along with other predicted deal structure attributes (including such as lend amounts (appetite), willingness to be lead lender and other characteristics). The disclosed innovation provides as output a configured structure of an augmented deal structure.

It is to be appreciated that components of the configurator 102 work together to provide this synergistic structure, For example, aggregator component 110 may aggregate internal proprietary data the provides an asymmetric advantage over public data, and the aggregator component provides for the different data to be transformed into a form compatible with each other, as transformed by the transformer component 112. Rather than manual system which often may become overly driven by price considerations, the configurator 102 provides a structure leveraging the applied algorithms (as will be discussed herein) to leverage natural increases in speed of processing with higher quality along assurance factors derived by the transformer 112 synthesizer 114 and mlaaa 116 components.

In other words, it is to be appreciated that the standard manual models of arranging credit facilities are often driven by price competition and that such drivers often are in the opposite direction of the disclosed innovation. Rather than cost drivers limiting the among of manual time and manual capture of deal parameters, the disclosed innovation leverages not only the speed of computers, but more so, leverages an improved arrangement of components providing leveraged accessibility of proprietary and public data integrated by integrator components, that along with machine learning components intelligently feed algorithms (for example, modified knapsackers, as will be discussed herein) to create augmented deal structure along with confidence levels of the predictions of key characteristics.

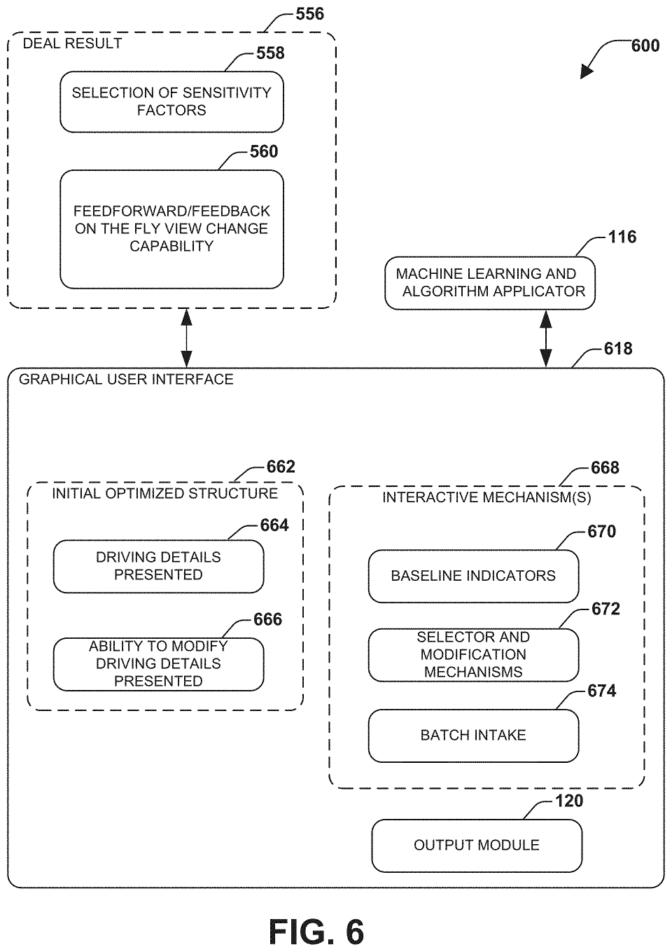

These deal structures are presented to a user through a graphical user interface 118, which will be discussed in relation to FIG. 6. It is to be appreciated that graphical user interface 618 may provide for a variety of interactive modifications that provide for perturbation and sensitivity analysis along a number of mlaaa 116 or synthesizer 114 provided characteristics, as will be discussed in relation to FIG. 6 later. Configurator 102 in some embodiments has a “batch mode” capability and may interact with an output module 120 to provide various forms of reports and sensitivity analysis reports along a spectrum of possible perturbations.

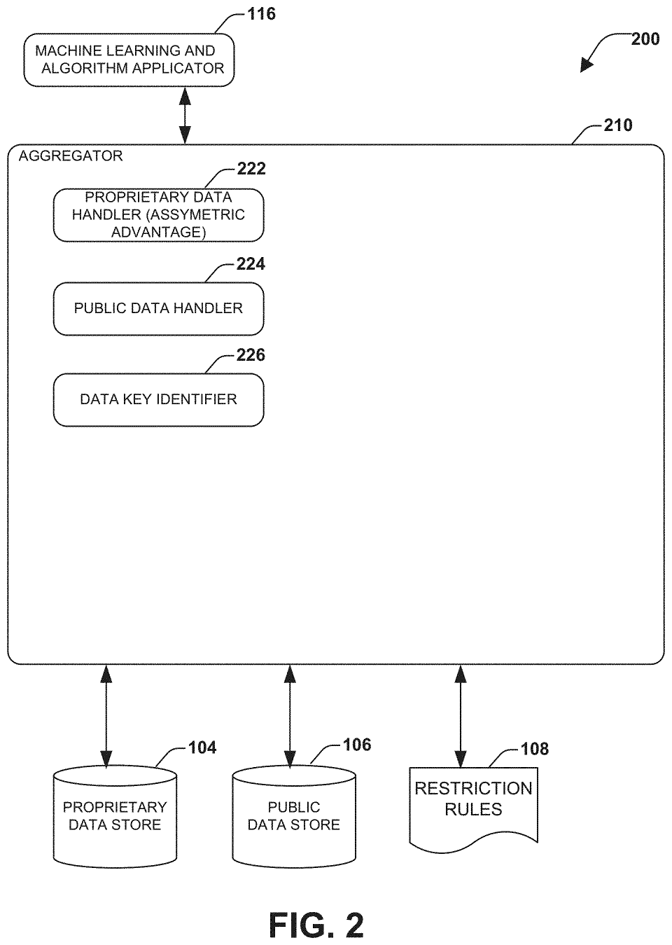

Turning now to FIG. 2, illustrated is an example system 200 with components according to one or more embodiments. In system 200, an aggregator component 210 is viewed in more detail. Aggregator component 210 may be an example of aggregator 110 as disclosed in FIG. 1. As pictured, aggregator 210 receives inputs from proprietary data store 104, public data store 106 and restriction rules 108, as has been discussed in relation to FIG. 1. Aggregator 210 may also interact with mlaaa 116. Aggregator 210 may comprise a proprietary data handler 222. Proprietary data handler 222 may identify, tag and provide an asymmetric advantage when inputs are aggregated with the action of a public date handler 224. Public data handler 224 and proprietary data handler 222 may interact with the mlaaa 116 to apply algorithms to collate and transform the data. Examples of such algorithms will be discussed later in relation to FIG. 4.

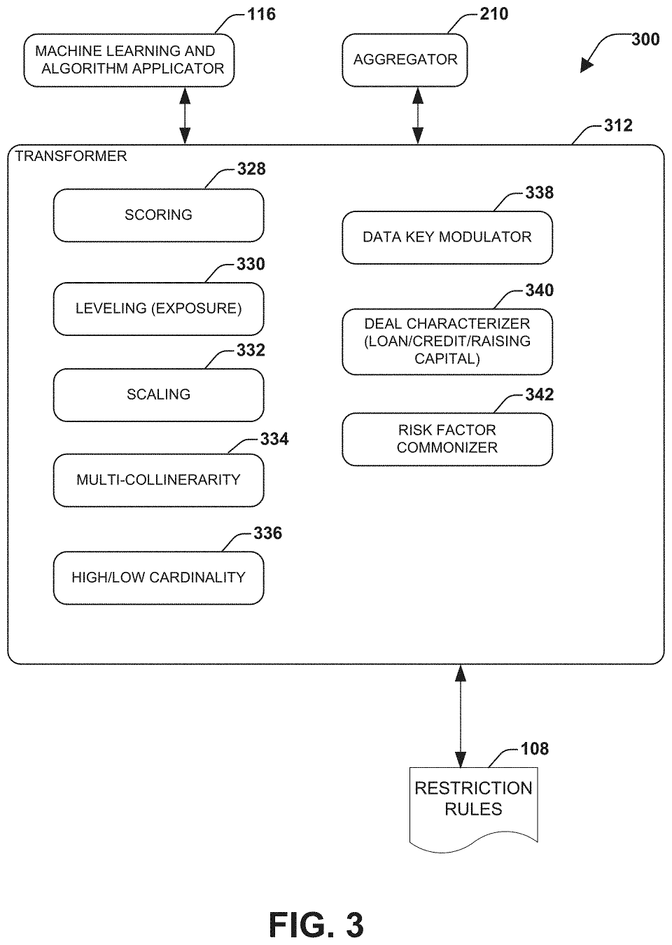

It is to be appreciated that embodiments of the aggregator 210 may provide a fast and user friendly interface that digests date coming from multiple sources and aggregates the different data inputs into a coalesced operational “private” data, augmenting the proprietary data. The aggregator 210 also acts to start forming deal structure based on the type of deal being contemplated as driven by restriction rules 108. Aggregator 210 may provide deal structure alignment and provision of structure for a mlaaa 116 (in conjunction with transformer component 312, to be discussed in relation to FIG. 3, later) to provide predictive algorithm application indicators, along with deal attributes, for example, in a credit facility deal, facility features may be identified and relative driving strength of various features may be noted.

In an embodiment, a user owned database may provide a far richer view of deals and deal history. For example, a proprietary data store may supply a richer view of the syndicated loan market. Such data collected by a user mostly on historical syndicated efforts by the user will be richer in content than external sources (such as, for example, EDGAR, Shared National Credit and DealScan). This asymmetric information provides the user with an edge over its competitors, and the aggregator component 210 integrates this advantage.

For another example, deal data may contain characteristics of complete views of hundreds of prior deals of that type of deal. Internal data may also include data on transactions in which the user was not a party. This data may also be in the hundreds of data characteristics, and while this additional data may be more partially complete than internal deals, the aggregator 210 component aligns the particular features of the data to allow a more systematic transformation.

Aggregator 210 may comprise data key identifier component 226. Data key identifier component 226 may through restriction rules 108 and mlaaa 116 identify particular subsets of data keys as related to subsets of types of deals. For example, in a credit facility deal, data keys may be identified as issuer, launch date long and deal size. Data key identifier 226 may also identify data keys from lender activity, as a source containing invite commit and allocation amounts in addition to invited and declined indicators. Continuing in an example of a credit facility deal, data keys available may include issuer, launch date, lender and deal amount. Data key identifier 226 may also identify data keys from investor activity data. Continuing in an example of a credit facility deal, data keys available may include issuer, launch date, lender and deal amount.

It is to be appreciated that aggregator component 210 may interact with transformer component 312 (as will be discussed later) in a two way information flow in order to perform the various functions within aggregator 210.

Turning now to FIG. 3, illustrated are further example system components according to one or more embodiments 300, specifically transformer component 312. Transformer component 312 may receive the outputs of aggregator component 210 as well as inputs from restriction rules 108. It is to be appreciated that mlaaa 116 may interact with transformer component 312 (as will discussed later in regards to FIG. 4). Transformer 312 may comprise a scoring component 328, a leveling component 330 a scaling component 332, a multi-collinerarity component 334 a high/low cardinality component 336, a data key modulator component 338 a deal characterizer component 340 and a risk factor commonizer component 342. Inputs from aggregator component 210 may be treated by scoring, leveling (for exposure), and scaling to transform the aggregated data into inputs for deal structure synthetization (as will be discussed later). Each of the components may interact with the other components as well as with mlaaa 116 in transforming the output of aggregator 210. Various data inputs (both from proprietary data store and the public data stores may exhibit characteristics of sparsity and high cardinality, which may limit the usefulness of a subset of methodologies and algorithms. The present innovation, through the use of the various components, augmented with machine learning are not limited by such concerns and provide substantially more than past methodologies taken singularly. For example, transformer component 312 may do more than merely accept the aggregate external data, but may apply techniques to decrease collinerization (data colinearity) and align data with proprietary data families, syncing the data to avoid other algorithm shortfalls. Spareness as may be evident in data sets as provided by public data stores may be alleviated by the aggregator component 210 and the scoring leveling and scaling components may transform the aggregated data. It is to be appreciated that a user's proprietary data may be richer than that data from a public store and the transformer functions may be applied to assist the aggregator component 210 to prepare the data for the transformer component to transform the data sets. Data keys identified in aggregator 210 may be modulated by the data key modulator component 338. Transformation of data sets that may exhibit high chances of overfitting may be treated by a risk factor commonizer component 342 in order to avoid the danger of overfitting which may lower predictive power of algorithms. Data key modulator component 338 may act to reflect those inputs that may be deemed to not have sufficient historical information (for example, certain lender data that may not be as fully developed as other lender data) and would feed this into a confidence ranking mechanism of the data key modulator component. It is to be appreciated that the data key modulator component may interact with the mlaaa 116 to apply machine learning and predictive algorithms in determining predictions of overall and relative confidence, as will be discussed later in relation to FIG. 4.

It is to be appreciated the ability of the innovation to handle and deal with the problem of high cardinality of data through a high/low cardinalilty component 336 provides significantly more than merely “just automating” a possible manual effort. The high/low cardinality component 336 may interact with a scaling component 332 to transform data exhibiting high or low cardinality and prepare the outputs of the transformer component 312 for input into the synthesizer component 114 for example as shown in FIG. 1. Data that may exhibit this tendency and which would be treated by the high/low cardinality component 336 may be for example, Moody's, S&P and Fitch ratings which through their own disparity from one to another may create several hundred different categories from -/-/- to [-/NR/NR]. High/low cardinality component 336 may put rating agencies on the same scale, transforming ratings and creating a separate score (through for example scoring component 328), for each agency and align scores along common scale (through for example scaling component 332). It is to be appreciated that at least a subset of restriction rules 108 may be integrated into the ratings assignment transformation.

Another area in which the components working together can be differentiated from “mere automation” is in the resolution that compensates for the problem of multicollinearity. Several aspects of the aggregated data may show multicollinearity for a variety of deal features. For example in an example deal of a credit facility, pro rata pricing may be highly correlated with fee and multi-year pricing, and none of these factors may be significantly correlated with a Decline (Yes/No) factor. Interaction with mlaaa 116 may provide a correction factor to such multicollinearity y concerns through the multicollinearity component 334.

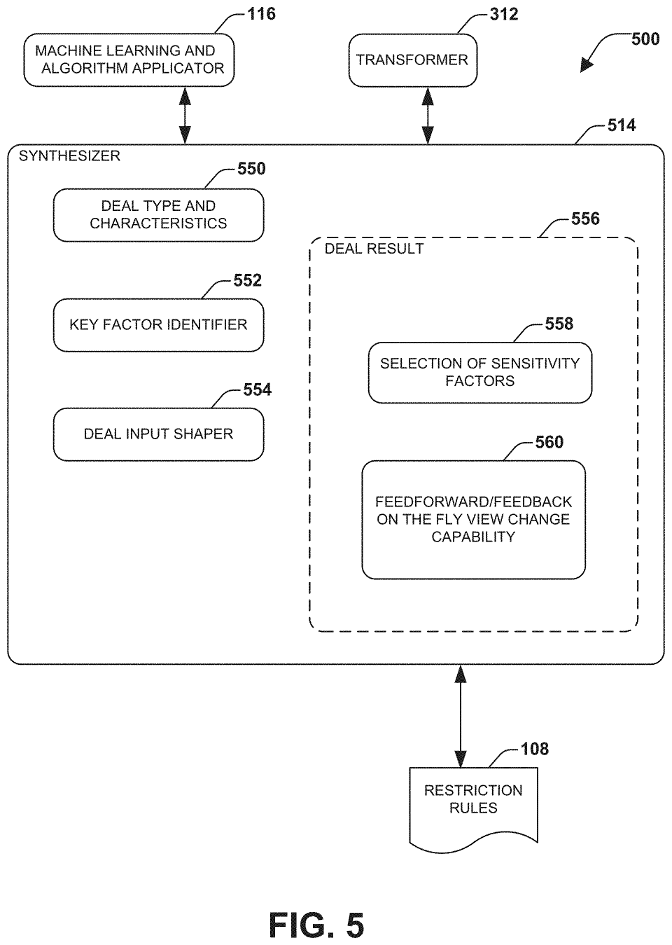

FIG. 4 is an illustration of example system components, according to one or more embodiments 400. Embodiment 400 displays example embodiments of a mlaaa 416 and the relation of mlaaa 416 to other components 448 and restriction rules 108. It is to be appreciated that other components 448 may be any of the components as discussed in previous FIGS. 1-3. Mlaaa 416 may employ machine learning techniques as is known in the art. Input to the mlaaa includes at least a subset of restriction rules 108. Mlaaa416 may be an example of mlaaa as discussed in FIGS. 1-3, as well as FIG. 5.

Mlaaa 416 may also comprise particular algorithms that may be applied with in mlaaa416 or in conjunction with other components 448. One such example algorithm is modified knapsack 444. A general knapsack algorithm may be modified per a subset of restriction rules 108 and may utilize modified approaches to a knapsack approach in evaluating and transforming data sets that have been aggregated and transformed as discussed in relation to FIGS. 2 and 3. The modification from a general knapsack approach may include sequential regression/classification techniques. Algorithms may predict a number (poison/negative binomial regression) or likelihood (logistic regression) of expected deal characteristics, for example, in a credit facility deal, the characteristic of which participants to include in the deal structure may based on historical data and the deal parameters as a series of axis lines to which a modified knapsack algorithm may be applied. It is to be appreciated that the computing power of applying such techniques quickly approaches “Big Data” levels, or in other words, quickly eclipses the scale beyond which any human could possibly compute the sets of algorithms as applied to aggregated and transformed data sets. The modified knapsack algorithm 444 then can, in relation to component synthesizer 514 as will be discussed in relation to FIG. 5, predict commitment (for example, as one of many deal characteristics) in a given deal using a regression or a classification model. Other embodiments may also employ modification based on other algorithms, such as for example, a k-nearest neighbor algorithm of the multiple data sets under consideration.

Mlaaa416 may also comprise a modified Herfindahl-Hirschman Index (“mod-HHI”) 446. Non-modified HIM is a tool often used in other application of data synthesis, especially in a different field of market concentration effects in relation to anti-trust policing efforts. The present innovation realizes a previously unconnected benefit by applying the tool in a different manner, so as to evaluate and through machine intelligence techniques predict a variety of deal characteristics that may impact each other and provide for augmented synthesis of deal structures. The mod-HHI 446 may apply a straightforward nonlinear optimization technique of a (sum of squared shares) subject to constraints, such as for example: Each share is >=0; Each share<=25%; and selected shares sum to 1. By modifying the technique and reformulating the technique to apply it to a variety of elements of a particular deal structure. For example, a syndication allocation as a constrained portfolio selection model, the power of Big Data analytics can be effectively leveraged in the application of this tool in a new manner to assist the synthesizer component 514, as will be discussed in relation to FIG. 5 later. The sets of algorithms may be provided as of a plurality of algorithms that may be applied singularly, in combination or in modified forms. 1

FIG. 5 is an illustration of example system components, according to one or more embodiments 500. In particular, embodiment 500 portrays a synthesizer component 514 in relation to a mlaaa 116, a transformer component 312, and restriction rules 108. Synthesizer 514 may receive aggregated and transformed results from transformer 312 and with sub-components deal type and characteristics 550, key factor identifier component 552, and deal input shaper 554 generates deal result 556. Deal type and characteristics component 550 provides, based on received input from transformer 312 and restriction rules 108, the overall structure to a deal result 556. Key factor identifier 552 through the results of mlaaa 116 fills in the deal result 556 with identified key factors. It is to be appreciated that the particular key factors may change from deal type to deal type and even be impacted by other key factors through other system processes such as by other components in the system (for example, data key identifier 226 of aggregator 210 as discussed in relation to FIG. 2, as well as data key modulator 338 of transformer 312 as discussed in relation to FIG. 3.

Deal input shaper component 554 augments deal result 556 by synthesizing the shape or structure of the deal configuration. These components working together create a user-friendly optimization setup that takes model predictions (bases on aggregated and transformed inputs and application of mlaaa 116 and generate a “best configuration” as a default deal result 556.

For an example of the deal result 556 as generated by a deal type and characteristics component 550, consider a deal being the formation of a structure for a credit facility. In manual systems, a driver may be identified as desiring to minimize (as oppose to optimize) the number of lenders that will make up the structure of the credit facility. With this innovation, the components work together and instead of minimizing (or merely lowering) lender count (as may be the result of a drive to minimize a cost of the credit facility structure), the disclosed innovation increases the efficacy of a resultant structure. In configuring an optimal loan syndication, lowering the number of participants is not the only portion of an optimization. Generally speaking, there are benefits to be had with lowering a number of participants, but mere lowering is not the same as optimizing, because more than one attribute is in play; for example, an optimal structure level of number of participants is also dependent on a confidence level that the specifically chosen participants will join at predicted levels. The present innovation provides the optimized structure. This ability to predict the multiple characteristics is not currently available in the art. Currently no manual process takes this large multitude of input data details into account and the disclosed innovation provides not only the optimized output, but also includes sensitivity analytics that provide tools to show how sensitive any such “saddle points” of a result structure may be, and provides for tools to evaluate levels of perturbations that may slide into alternative arrangements based on either preselected (tied to credit facility of restriction rules) or open to user modifications of various terms. A provided default would be the optimum and components of the innovation, such as for example key factor identifier 552 of synthesizer 514 factors most closely tied to the identified lenders and their concerns, yielding a highly pertinent result set that currently no manual process (or automated version of a manual process) delivers.

In embodiments of the innovation, with particular deal structures, preliminary results have shown strong impact of loan size and invite amount on lenders' appetite. Results also show that neutral lenders (commit amount equals invite) seem to respond less to loan features other than the deal and invite amount. Further, practical results in an embodiment show in one example that loan features mostly impact Weak lenders (Commit amount less than invite) with multi-year revolving credit tenor and pricing having a negative impact on the odd ratio. For a decline group, increasing fees lowered the probability of decline. In this example group, deal and invite amount have opposing impact though increasing fee revealing a lowering of a probability of decline

Within deal result 556, it is to be appreciated that a selection of sensitivity factors 558 and a feedforward/feedback on the fly view change capability 560 is provided. These provisions permit an optional user override of the provided structured deal result. Selection of sensitivity factors 558 may be tied to key factor identifier component 552 and deal input shaper component 554 to generate a prioritized list of factors. It is to be appreciated that the prioritized list of factors may in conjunction with feedforward/feedback on the fly view capability component 560 be viewed at from a number of perspectives. Often it may be advantageous to view a finalized structure from the viewpoint of a user as well as from a viewpoint of any number of selected target participants.

FIG. 6 is an illustration of example system components, according to one or more embodiments 600. Displayed in embodiment 600 is a high level view of how a deal result (for example, a deal result 556 as disclosed in relation to FIG. 5.), may be provided to a graphical user interface 618. Deal result 556 (with features selection of sensitivity factors 558 and feedforward/feedback on the fly view change capability 560) may be associated with a graphical user interface 618. It is to be appreciated that the graphical user interface 618 may be associated via a web connection (not shown) or other computer-related connection (not shown). Initial optimized structure component 662 is to be understood to be a component that reveals deal result 556 on the graphical user interface 618. Initial optimized structure 662 may provide for driving details presented 664. It is to be appreciated that the driving details presented 664 may vary from type of deal to type of deal or even within a single type of deal based on a number of factors driving through the inputs, through the aggregation of the inputs, the transformation of the aggregated inputs and the synthesis of the deal result, or subsets of these items. For example, in a deal that is a creation of a structure for a credit facility, driving details presented 664 may include factors such as an optimized number of identified target lenders, a level of commit per identified target lender, and a probability of commit at the specified level. Component ability to modify driving details presented 666 is associated with deal result 556 feature feedforward/feedback on the fly view change capability 560. Ability to modify driving details presented 666 is also associated with interactive mechanism(s) 668, a component of graphical user interface 618. It is to be appreciated that interactive mechanism(s) 668 may have a sub-component baseline indicators 670 that may be associates with deal result 556 feature selection of sensitivity factors 558. Baseline indicators 670 may present on the graphical user interface in most any manner of graphical visualization, as may be known in the art. Interactive mechanism(s) 668 may also comprise selector and modification mechanisms 672. These mechanisms may be, without limitation, radio button inputs, pull-down lists, slider bars and the like. It is to be appreciated that selector and modification mechanisms 672 will be associated with ability to modify driving details presented 666 which is associated with elements of deal result 556. In addition to such an association for on the fly change capability, interactive mechanism(s) 668 may also feature a batch intake module 674. Batch intake 674 may provide for intake of a range of conditions and may accept such input in most any batch mode as may be known in the art. Graphical user interface 618 may also provide for an output module 120. It is to be appreciated that output module 120 may be separate from graphical user interface 618 as well (as disclosed in relation to FIG. 1).

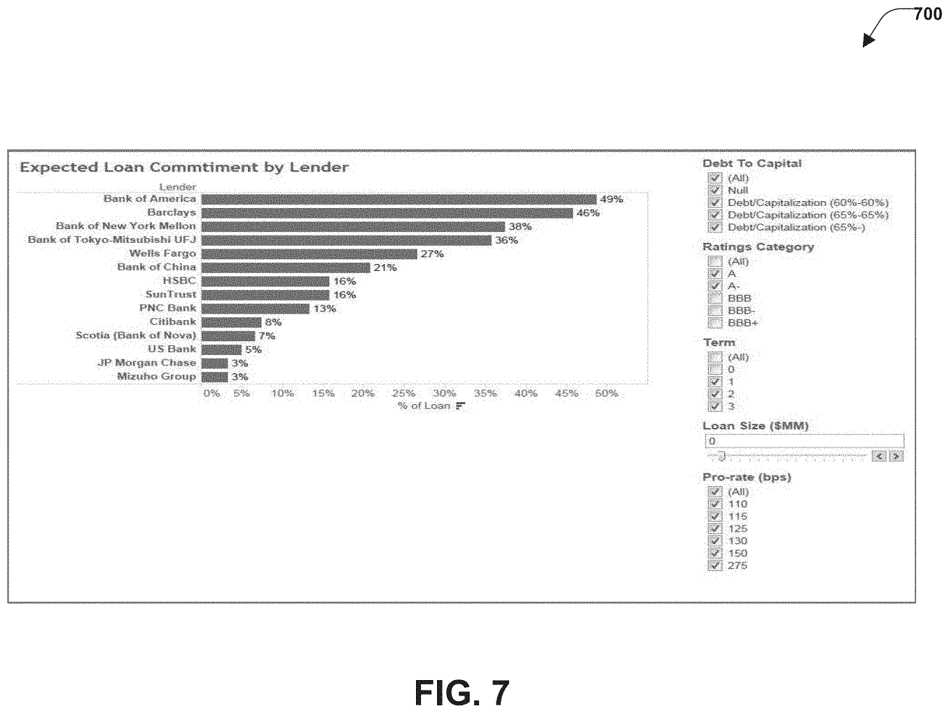

Turning now to FIG. 7, presented is an illustration of example system components, according to one or more embodiments 700. Embodiment 700 provides a mock GUI presentation for an example credit facility deal structure result, providing details of identified selected target vendors, each selected target vendor loan percentage with interactive mechanism(s) of check boxes for selected sensitivity factors of Debt To Capital, Ratings Category, Term, and Pro-rate (bps), and a slider bar for the selected sensitivity factor of loan size.

The example embodiment may include an output dashboard scalable to include a variety of pre-selected but modifiable characteristics of the credit facility. As shown in FIG. 7 (a non-limiting example), selected sensitivity parameters may be presented in multiple radio button selection areas as well as sliding bar functional modifiers. The initial result may be presented capturing the key highlights of the augmented credit facility highlighting the number of lenders (an item not typically included in manual modes, as well as for each of the listed numbers of lenders indicators for such items as predicted comfort size of loan within the credit facility as well as (not shown) probability of acceptance of the package.

The example graphical user interface may also present preselected variables that may be designated as the most pertinent variables (but offers options for changing these variables) that may alter the composition of the credit facility and tools generated for a user to employ sensitivity analysis revealing attributes. Graphical user interface tools as may be known in the art may include a host of radio button and/or slider type tools and the like. This aspect of the innovation may be highly valuable for contingency planning or evaluating sensitivity of deal structure, for example, credit facility bank makeup, particular in relation to the other identified targets. Nothing in traditional manual processes provides this type of functionality.

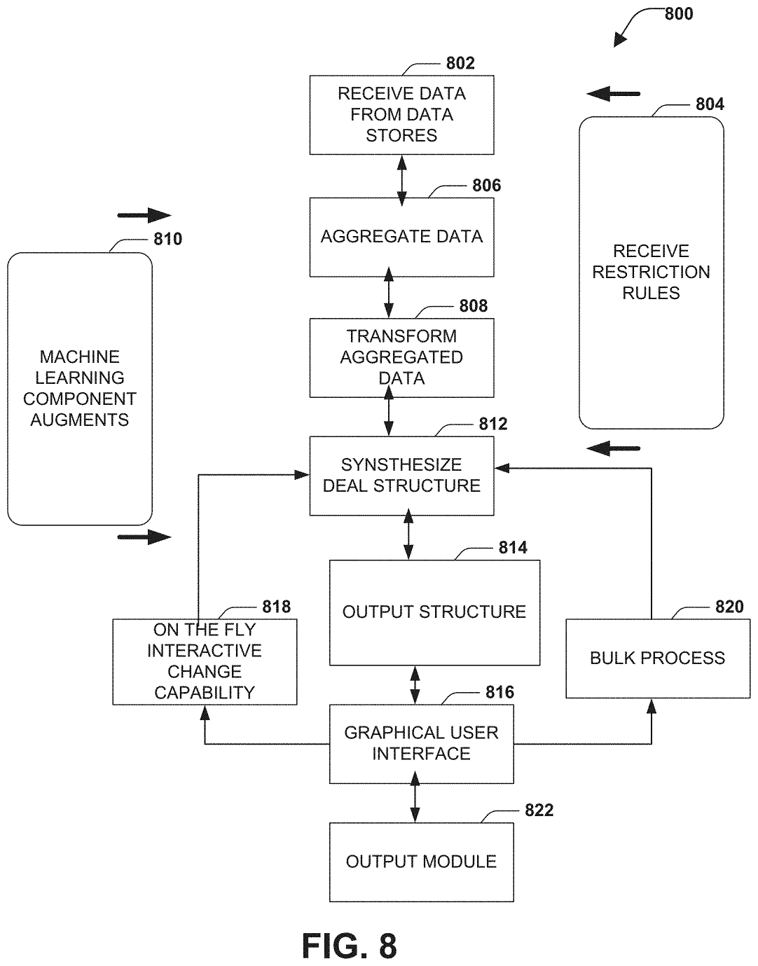

Turning now to FIG. 8, illustrated is an embodiment of a method 800 according to one or more aspects of the disclosure. Method 800 begins at step 802, wherein data is received from data stores. It is to be appreciated that the data stores from which data may be received may be either proprietary data stores (such as for example, proprietary data store 104 as discussed in FIG. 1) or may be received from public data stores (such as for example public data store 106 as discussed in FIG. 1), or a combination of proprietary and public data. Next step is at 806 wherein data is aggregated. It is to be appreciated that through several steps restriction rules (step 804) (or subsets of restriction rules) and machine learning component augmentations (step 810) may be applied to a number of steps. This is portrayed in FIG. 8 as heavy arrows from differently shaped boxes which span from top and bottom of the larger differently shaped boxes. This process reflects the discussion of the components as previously discussed in FIGS. 1-6.

At step 806, data is aggregated, as may be aggregated by aggregator 110 of FIG. 1 or aggregator 210 of FIG. 2. The processed aggregated data proceeds to step 808 transform aggregated data. Again, it is to be appreciated that machining learning component augments 810 and received restriction rules 804 may be involved in this step. Step 808 may be completed as discussed with component transformer 112 of FIG. 1 or transformer 312 of FIG. 3.

The output from the transformer (the transformed aggregated data results) proceeds to step 812, wherein a deal structure is synthesized. Again, it is to be appreciated that machining learning component augments 810 and received restriction rules 804 may be involved in this step, as discussed previously in regards to synthesizer 114 of FIG. 1 and synthesizer 514 of FIG. 5. The result of the step 812 is output structure 814. Output structure 814 may be reflected as Deal Result 556 as disclosed in relation to FIGS. 5 and 6, discussed prior. Output structure 814 proceeds to a next step of graphical user interface 816. The display and the functionality available at step graphical user interface 816 may be as reflected in discussions of components graphical user interface 118 of FIG. 1 or graphical user interface 618 of FIG. 6, pertaining to those components functionality as described previously. For example, step on the fly interactive change capability 818 may be associated with an ability to modify driving details presented 666 portion of initial optimized structure 662 through, for example, a selector and modification mechanisms 672 of interactive mechanism(s) 618 as discussed in relation to FIG. 6. Similarly, bulk process step 820 may be associated with batch intake 674 as discussed in relation to FIG. 6. Each of these steps through the related mechanisms provide that the step of synthesize deal structure 812 may be re-engaged with new or modified inputs (not shown), generating a new output structure 814 being delivered to graphical user interface 816. At most any time during the original presentation or the changes along either path, step output module 822 may be engaged to output either the original augmented deal structure or the modified (for sensitivity analysis or perturbation analysis) deal structure.

Turning to FIG. 9 is a system 900 that indicates the technical context in which the innovation is placed. This other embodiment involves a computer-readable medium including processor-executable instructions configured to implement one or more embodiments of the techniques presented herein. An embodiment of a computer-readable medium or a computer-readable device devised in these ways is illustrated in FIG. 9, wherein an implementation 900 includes a computer-readable medium 902, such as a CD-R, DVD-R, flash drive, a platter of a hard disk drive, etc., on which is encoded computer-readable data 904. This computer-readable data 904, such as binary data including a plurality of zero's and one's as shown in 904, in turn includes a set of computer instructions 906 configured to operate according to one or more of the principles set forth herein. In one such embodiment 900, the processor-executable computer instructions 906 may be configured to perform a method 908, such as the method 900 of FIGS. 9A and 9B. In another embodiment, the processor-executable instructions 906 may be configured to implement a system, such as the system 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or most any combination thereof to control a computer to implement the disclosed subject matter. The term “article of manufacture” as used herein is intended to encompass a computer program accessible from most any computer-readable device, carrier, or media. Of course, many modifications may be made to this configuration without departing from the scope or spirit of the claimed subject matter.

FIG. 10 and the following discussion provide a description of a suitable computing environment to implement embodiments of one or more of the provisions set forth herein. The operating environment of FIG. 10 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (pdas), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as discussed herein. Computer readable instructions may be implemented as program modules, such as functions, objects, Application Programming Interfaces (apis), data structures, and the like, that perform one or more tasks or implement one or more abstract data types. Typically, the functionality of the computer readable instructions are combined or distributed as desired in various environments.

FIG. 10 illustrates a system 1000 including a computing device 1002 configured to implement one or more embodiments provided herein. In one configuration, computing device 1002 includes at least one processing unit 1004 and memory 1006. Depending on the exact configuration and type of computing device, memory 1006 may be volatile, such as RAM, non-volatile, such as ROM, flash memory, etc., or a combination of the two. This configuration is illustrated in FIG. 10 by dashed line 1008.

In other embodiments, device 1002 includes additional features or functionality. For example, device 1002 may include additional storage such as removable storage or non-removable storage, including, but not limited to, magnetic storage, optical storage, etc. Such additional storage is illustrated in FIG. 10 by storage 1010. In one or more embodiments, computer readable instructions to implement one or more embodiments provided herein are in storage 1010. Storage 1010 may store other computer readable instructions to implement an operating system, an application program, etc. Computer readable instructions may be loaded in memory 1006 for execution by processing unit 1004, for example.

The term “computer readable media” as used herein includes computer storage media. Computer storage media includes volatile and nonvolatile, removable and non-removable media implemented in any method or technology for storage of information such as computer readable instructions or other data. Memory 1006 and storage 1010 are examples of computer storage media. Computer storage media includes, but is not limited to, RAM, ROM, EEPROM, flash memory or other memory technology, CD-ROM, Digital Versatile Disks (dvds) or other optical storage, magnetic cassettes, magnetic tape, magnetic disk storage or other magnetic storage devices, or any other medium which may be used to store the desired information and which may be accessed by device 1002. Any such computer storage media is part of device 1002.

Device 1002 includes input device(s) 1012 such as keyboard, mouse, pen, voice input device, touch input device, infrared cameras, video input devices, or any other input device. Output device(s) 1014 such as one or more displays, speakers, printers, or any other output device may be included with device 1002. Input device(s) 1012 and output device(s) 1014 may be connected to device 1002 via a wired connection, wireless connection, or any combination thereof. In one or more embodiments, an input device or an output device from another computing device may be used as input device(s) 1012 or output device(s) 1014 for computing device 1002. Device 1002 may include communication connection(s) 1016 to facilitate communications with one or more other devices 1018, and such communication may occur over a network, for example network 1020. Additionally, modules or components may be provided that are specialty components 1022, for example, as may be seen in FIG. 1, aggregator component 110, transformer component 112, synthesizers component 114, machine learning and algorithm applicator component 116 and graphical user interface component 118 are specialty components 1022. Specialty components 1022 may be configured, for example, in order to transform data structures in a particular manner, or for another example, specialty components 1022 may enable machine learning processes to interact with data sets. Other specialty components 1022 may be configured to provide interactions with users in either a bulk or batch mode, or in an interactive setting.

Although, in accordance with some aspects, the subject matter has been described herein in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. For features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A computer system for creating an augmented deal structure that comprises:
a processor coupled to a non-transitory memory that includes instructions that when executed by the processor cause the processor to perform the following operations:
aggregate proprietary and public data;
transform, via a transformer component, the aggregated data according to at least a set of restriction rules with a set of transforms that comprises scoring, leveling, scaling, multi-collinerarity, high/low cardinality, data key modulator, deal characterizer, and risk factor commonizer where the transformer component employs one of a modified, knapsack algorithm, a modified k-nearest neighbor algorithm, or a modified Herfindahl-Hirschman Index that employs a nonlinear optimization technique in conjunction with the set of transforms to transform the aggregated data, where one of the modified knapsack algorithm or the modified k-nearest neighbor algorithm is modified via a sequential regression technique or a classification technique;
synthesize at least an output of the transformed aggregated data into an augmented deal structure;
present a first graphical user interface that provides a user an option to select a sensitivity factor;
receive a user selection of the sensitivity factor; and
present a second graphical user interface that provides selected characteristics of the augmented deal structure in a deal result in response to the selection of the sensitivity factor, the second graphical user interface providing at least one of an interactive analysis or intake for a batch processing of a set of modifications.

2-6. (canceled)

7. The system of claim 1, wherein the deal structure is a credit facility and the output of the synthesizer component provides the augmented deal structure in at least including:
a number of entities asked;
a level of ask per entity; and
a predicted success factor for the augmented deal structure.

8. The system of claim 7, wherein the first graphical user interface provides:
a consolidated view of the synthesized credit facility with indicators of selected characteristics of the credit facility, and
interactive selector mechanisms that upon selection and modification provide sensitivity analysis capability from a predicted initial data structure to a newly created data structure with an impact score of a changed credit facility.

9. The system of claim 7, wherein the first graphical user interface includes selector mechanisms comprised of at least one of a plurality of radio buttons, a plurality of slider mechanisms or a combination of the pluralities of radio buttons and slider mechanisms.

10. The system of claim 1, wherein the deal structure is a peer lending arrangement and the restriction rules are tailored to peer funding.

11. (canceled)

12. The method of claim 23, wherein the restriction rules comprise a subset of rules controlling types of deals, and another subset of rules controlling user affiliation and proprietary data aggregation.

13. The method of claim 12, wherein the deal structure is a peer lending arrangement and the restriction rules are tailored to peer funding.

14. The method of claim 12 wherein the deal structure is a credit facility and the synthesizing the output of the transformed aggregated data includes at least:
a number of entities asked;
a level of ask per entity; and
a predicted success factor for the deal.

15. The method of claim 14 wherein the second graphical user interface further comprises a consolidated view of a synthesized credit facility with indicators of selected characteristics of the credit facility.

16-18. (canceled)

19. The method of claim 23, wherein the first graphical user interface comprises:
providing at least the transformed aggregated data, the selection of the sensitivity factor and indicators that provide for interactive processing capability, batch process capability or both capabilities; and
receiving a sensitivity factor selection.

20. The method of claim 19, wherein
the graphical user interface includes selector mechanisms that are comprised of at least one of a plurality of radio buttons, a plurality of slider mechanisms or a combination of the pluralities of radio buttons and slider mechanisms.

21. (canceled)

22. (canceled)

23. A method of creating a predicted augmented deal structure from data inputs and restriction rules, the method comprising:
aggregating proprietary and public data;
transforming, via a transformer component, the aggregated data according to at least a set of restriction rules with a set of transforms that comprises scoring, leveling, scaling, multi-collinerarity, high/low cardinality, data key modulator, deal characterizer, and risk factor commonizer where the transformer component employs one of a modified knapsack algorithm, a modified k-nearest neighbor algorithm, or a modified Herfindahl-Hirschman Index that employs a nonlinear optimization technique in conjunction with the set of transforms to transform the aggregated data, where one of the modified knapsack algorithm or the modified k-nearest neighbor algorithm is modified via a sequential regression technique or a classification technique;
synthesizing at least an output of the transformed aggregated data into an augmented deal structure;
presenting a first graphical user interface that provides a user an option to select a sensitivity factor;
receiving a user selection of the sensitivity factor; and
presenting a second graphical user interface that provides selected characteristics of the augmented deal structure in a deal result in response to the selection of the sensitivity factor, the second graphical user interface providing at least one of an interactive analysis or intake for a batch processing of a set of modifications.

24-26. (canceled)

27. The method of claim 23, wherein the method further comprises applying algorithms based on a combination of the modified knapsack algorithm and the modified Herfindahl-Hirschman Index algorithm.
